(19) United States
(12) Patent Application Publication
(10) Pub. No.: US 2018/0309872 A1
(43) Pub. Date: Oct. 25, 2018

(54) TELECOMMUNICATION PARAMETER CHANGE NOTIFICATION SYSTEM AND METHOD

(71) Applicant: Neustar, Inc., Sterling, VA (US)

(72) Inventors: Thomas G. McGarry, Arlington, VA (US); W. Andrew Stickel, Fairfax, VA (US)

(21) Appl. No.: 15/495,514

(22) Filed: Apr. 24, 2017

(51) Int. Cl. H04M 3/42; H04Q 3/00

(52) U.S. Cl. CPC H04M 3/42297; H04Q 2213/13149; H04Q 3/005

(57) ABSTRACT

Systems and methods for notifications related to the management of telecommunication parameters in a telecommunications network are disclosed. For example, a system receives a list of telecommunication parameters and monitors any changes related to one or more telecommunication parameters in the list. Upon detecting a change, the system notifies a user using, for example, a report that provides information of the change, as well as other pertinent information. The invention further relates to the concept of managing communications involved as part of the process of porting telephone numbers, such that the number of steps in the porting process are reduced. The system and method achieve this by modifying the steps undertaken during both the user verification and the routing update phases of the porting process.

### TECHNICAL FIELD

The following disclosure relates to systems and methods for management of telecommunication parameters in a telecommunications network. Particularly, the following disclosure relates to the concept of managing notifications and/or communications between service providers, number portability administrator, other entities as part of managing telecommunication parameters, for example, when a telephone number is ported from one carrier to another.

### RELATED APPLICATION

Applicants incorporate by reference in its entirety herein co-pending U.S. application Ser. No. 15/426,803.

### BACKGROUND AND SUMMARY

Local number portability (LNP) in the US was initially created for landline service. LNP for mobile telephone numbers and Voice over IP (VoIP) followed a few years later. LNP refers to the ability of a customer of an existing fixed-line or mobile telephone number assigned by an old service provider (“old SP”) or local exchange carrier (“LEC”) to reassign the number to another carrier (“Service Provider Portability”), move it to another location (“Geographic Portability”), or change the type of service (“Service Portability”). Typically, the old SP is involved in the entire porting process to ensure that the customer does not have a long period without service, especially access to 911. For example, when porting a landline number, the port has to be coordinated with the process of the old SP removing the wires from their switch and the new SP connecting the wires from the user to their switch. This process can take days and even weeks.

Traditionally, porting a telephone number involves two phases: 1) user verification and 2) routing update. In the user verification phases, when the customer requests a port to the new SP, the new SP notifies the old SP of the pending port and provides some information related to the user for verification. The new SP also provides a date and time for the port. The old SP verifies the user and the date and time. It can also reject the verification if there is an error, and reject the date and time if it does not meet its needs or criteria. User verification communications could go directly between the old SP and the new SP. Alternatively, user verification communications could go through a LNP Administrator (LNPA) or go through a process managed by the LNPA.

Once the user is verified the two SPs enter the routing update phase that could involve an LNPA. The new SP creates a pending port with the LNPA including the date and time. The old SP can be notified of the port by the LNPA. If the old SP agrees with the port, date and time, they send an acknowledgement to the LNPA. The LNPA can then notify the new SP. If the old SP does not acknowledge the port, control of the telephone number (“TN”) in the LNPA is transferred to the new SP after certain timers expire. The new SP activates the port at the scheduled date and time, the old SP is notified by the LNPA, and the new routing information for the TN is updated to all SPs connected to the LNPA.

FIG. 1 illustrates the processing steps and porting process for a typical inter-service provider port. In this case, a user is switching to a new communications service provider and wants to keep his existing TN. First, at step 102, the new service provider notifies the old service provider of the requested port. At step 104, the old service provider is asked to validate the subscriber's information. The old service provider, at step 106, confirms the subscriber's information and notifies the new service provider. The new service provider, at step 108, notifies an administrative agency LNPA (e.g., the Number Portability Administration Center (NPAC) in the United States) of the requested port. Other countries have similar administrative agencies (e.g., Canadian Radio-television and Telecommunications Commission (CRTC) in Canada). The LNPA, at step 110, creates a pending port and sends a notification to the old service provider. Optionally, at step 112, the old service provider notifies the LNPA that it concurs with the port. The new service provider, at step 114, notifies the LNPA to activate the port. Finally, at step 116, the pending port is activated in the LNPA and a new LNPA record is created and broadcast to the telecommunications industry network. Each LNPA record, referred to as a Subscription Version, may contain various pieces of information about the TN, including the TN, the current assigned service provider ID (SPID), the service provider type (such as wireless or wireline), the Location Routing Number (LRN), the Non-geographic Location Routing Number (NGLRN), SS7 Destination Point Codes (Line Information Database (LIDB), Call ID with Name (CNAM), Custom Local Area Signaling Services (CLASS), etc.), service type (such as class 2 VoIP or pre-paid wireless), alternative SPID (to identify a reseller), billing ID, and end user location and type.

### BRIEF DESCRIPTION OF THE DRAWINGS

The foregoing and other objects, features, and advantages of the invention will be apparent from the following description of preferred embodiments as illustrated in the accompanying drawings. The drawings are not necessarily to scale. Emphasis instead has been placed upon illustrating the principles of the invention.

FIG. 1 illustrates some salient operations of a porting process according to an illustrative embodiment of the invention;

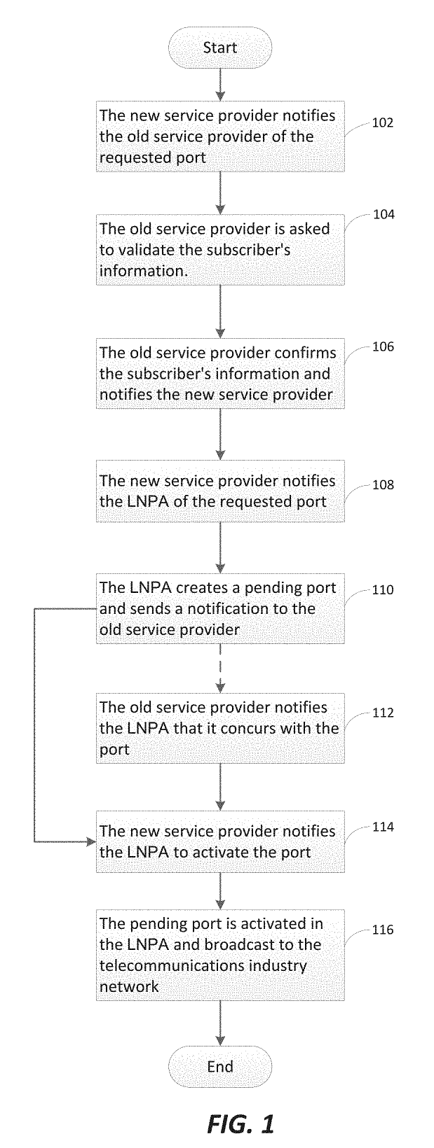

FIG. 2 is a block diagram illustrating an exemplary port notification system according to an illustrative embodiment of the invention;

FIG. 3 illustrates some salient operations of a telephone number porting notification method according to an illustrative embodiment of the invention;

FIG. 4 illustrates some salient operations of a telephone number porting notification method according to an illustrative embodiment of the invention;

FIG. 5 illustrates some salient operations of a telephone number porting notification method according to an illustrative embodiment of the invention;

FIG. 6A illustrates some salient operations of a telecommunication parameter change notification method according to an illustrative embodiment of the invention;

FIG. 6B illustrates some salient operations of a telephone number porting notification method according to an illustrative embodiment of the invention;

FIG. 6C illustrates an example of a change report according to an illustrative embodiment of the invention; and

FIG. 7 illustrates the components of a computer system implementing the telephone number porting notification system according to various embodiments.

### DETAILED DESCRIPTION

Porting a TN for mobile and VoIP is not as complex as landline. For example, mobile and VoIP SPs can activate originating service for their customers almost immediately. LNP, which effects the customer's terminating service (incoming calls), has to rely on the LNPA processes. Mobile SPs may be treated differently by the LNPA. For example, the timers that transfer control with the LNPA from the old SP to the new SP may be shorter for mobile SPs than those for landline SPs. In contrast, VoIP SPs typically use the landline timers. As mentioned above, depending on the timers, LNP can take days and even weeks. It would be more efficient if the number of steps involved in LNP were reduced, especially for SPs that do not have to rely on the process of adding and removing landline wires to the user (e.g., mobile and VoIP SPs). Efficiencies in the LNP process can be achieved during both the user verification phase and the routing update phase.

Based on the foregoing, it is evident that there exists a need for a system and method which reduces the time taken for LNP. There also exists a need for a system and method which reduces the number of communications between the SPs and the LNPA to further speed up the porting process. Additionally, there exists a need for a system and method that enables the monitoring of changes that may occur with regards to a TN or another pertinent telecommunications parameters. Examples of telecommunications parameters include, but are not limited to, TN, LRN, NGLRN, SPID, Alternative SPID, Subscription Version (SV) type (e.g., wireless, wireline, VoIP, etc.), URI, pseudo SV/LRN, caller identifier, Line Info Database (LIDB), SS-7 Destination Point Codes (DPCs), service type, billing identifier, etc. For example, a user (e.g., a SP, a third-party, etc.) may wish to track any changes that occur with regards to a TN, and receive notifications (e.g., in real-time or on a scheduled basis) for such changes.

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well-known devices, circuits, and methods are omitted so as not to obscure the description of the present invention with unnecessary detail. Further, the terminology used in the description presented below is intended to be interpreted in its broadest reasonable manner, even though it is being used in conjunction with a detailed description of certain specific examples of the technology. Certain terms may even be emphasized below, however, any terminology intended to be interpreted in any restricted manner will be overtly and specifically defined as such in this Detailed Description section.

In an embodiment of the invention, the customer may be provided with a credential. The customer credential can be used to verify that the customer is an assignee (or an authorized user) of the TN. The customer credential could take multiple forms such as a digital certificate, user name and password, verification code, etc. The customer credential may be activated and provided to the user when the TN is assigned. The customer credential may be submitted to the new SP when the user requests the port. The credential could be verified by any entity, such as a SP, to which it is provided. The new SP could provide the user an updated credential when the TN ports. With the credential there may be no need to verify the user with the old SP. For example, once the new SP verifies the customer's credential, there may be no need to involve the old SP in the verification step.

In some embodiments of the invention, to make the porting process more efficient, the number of transactions between the new SP and old SP may be reduced. For example, the number of transactions may be reduced to a single port notification transaction. In some embodiments, the new SP could activate originating service to the customer, send a port notification to the old SP, and update the routing information in the LNPA. Upon receipt of the port notification message, the old SP may terminate service to the customer.

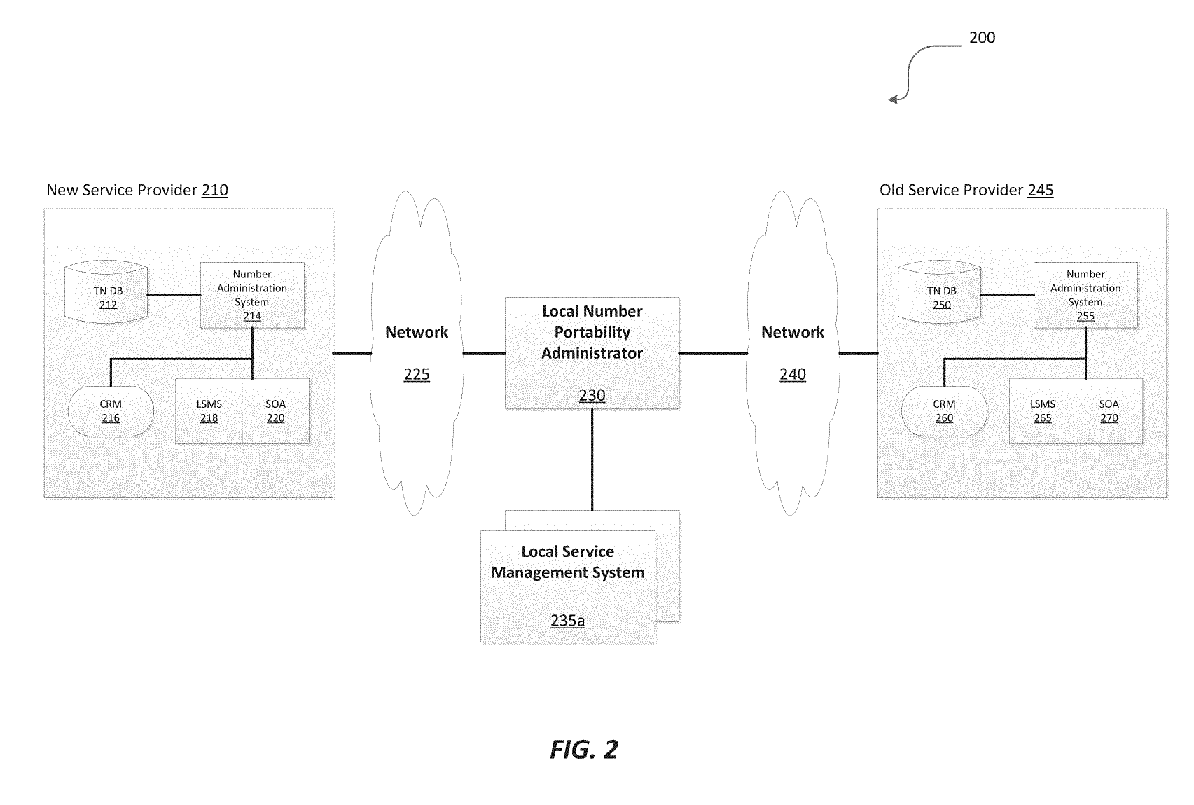

FIG. 2 is a block diagram illustrating an exemplary port notification system 200 according to an illustrative embodiment of the invention. The port notification system 200 comprises of a new SP 210 and old SP 245. The new SP and/or the old SP may comprise of a number administration system 214, 255, a service order administrator 220, 270, a database 212, 250, and a customer resource management system 216, 260, respectively. The databases 212 and/or 250 may store telephone numbers and associated metadata (e.g., the assignment information related to the telephone number, assignment information, etc.). The customer resource management systems 216 and/or 260 may interface with a Local Number Portability Administrator (LNPA) 230 (e.g., the Number Portability Administration Center (NPAC) in the United States) via a networks 225 and 240, respectively, such as the Internet, using their respective Service Order Administrators (SOA) 220 and 270. In some embodiments of the invention, the new SP and/or the old SP may interface with an intermediary that may connect to the LNPA 230. An intermediary may be useful if the SP does not want to deploy infrastructure to communicate with the LNPA. For example, a third-party may deploy the infrastructure to communicate with the LNPA and provide services to one or more SPs.

The new SP 210 and/or the old SP 245 may comprise one or more Local Service Management Systems (LSMS) 218, 265, respectively. The LNPA 230 may communicate with one or more additional service providers via their LSMS 235a . . . 235n. The LSMS (218, 265, and/or 235a . . . 235n) may receive changes to the information associated with telephone numbers. In some embodiments of the invention, the LNPA 230 may be maintained as distributed registries (including, but not limited to, using blockchain technology). In some embodiments of the invention, the information stored in the databases (e.g., the telephone number databases 212 and 250) may be stored in the form of a blockchain.

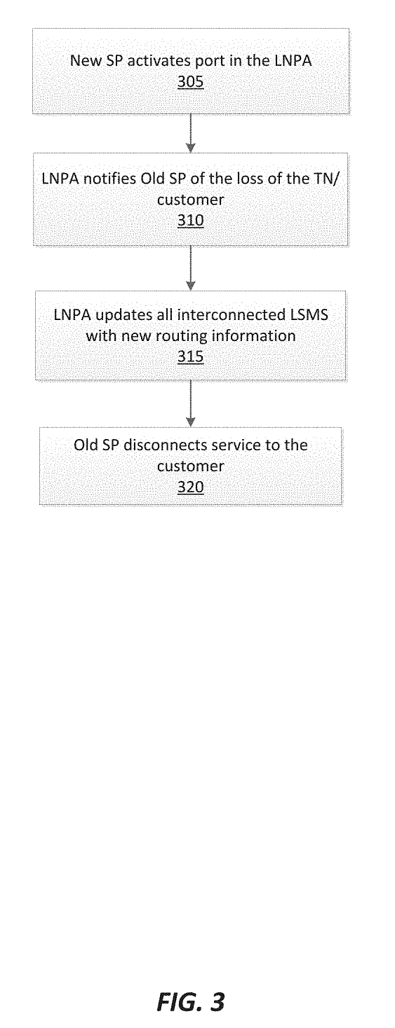

FIG. 3 illustrates some salient operations of a telephone number porting notification method according to an illustrative embodiment of the invention. The New SP may activate the port in the LNPA, at step 305. A port may be initiated, using for example, the processes discussed in co-pending U.S. application Ser. No. 15/426,803. A port activation request may include information such as, the service provider identifier, service provider name, authorization data, routing data, etc. Once the new SP activates the port in the LNPA, the LNPA may notify the old SP of the port request, at step 310. The LNPA may inform the old SP of the loss of the TN or the customer. In some embodiments of the invention, the old SP may not acknowledge the port notification. Additionally, the LNPA may send the details of the new SP to the old SP. The pending port may be activated and a new record associating the TN with the new SP is created and broadcast to the telecommunications industry (e.g., via the LSMS of the connected SPs), at step 315. Each record may contain various pieces of information including service information and administrative information. Examples of service information include: LRN, NGLRN and destination point code. Examples of administrative information include: PIN and billing identifier. Each record can contain various pieces of information about the TN including, the TN, the current assigned service provider ID (SPID), the service provider type (such as wireless or wireline), the LRN and/or NGLRN, SS7 Destination Point Codes (Line Information Database (LIDB), Call ID with Name (CNAM), Custom Local Area Signaling Services (CLASS), etc.), service type (such as class 2 VoIP or pre-paid wireless), Alternative SPID (to identify a reseller), billing ID, and end user location and type. Once the LNPA distributes the porting details to the telecommunications industry, the old SP may disconnect service to the customer, at step 320. The new SP may then be responsible for the ported TN, including performing call routing and call management operations.

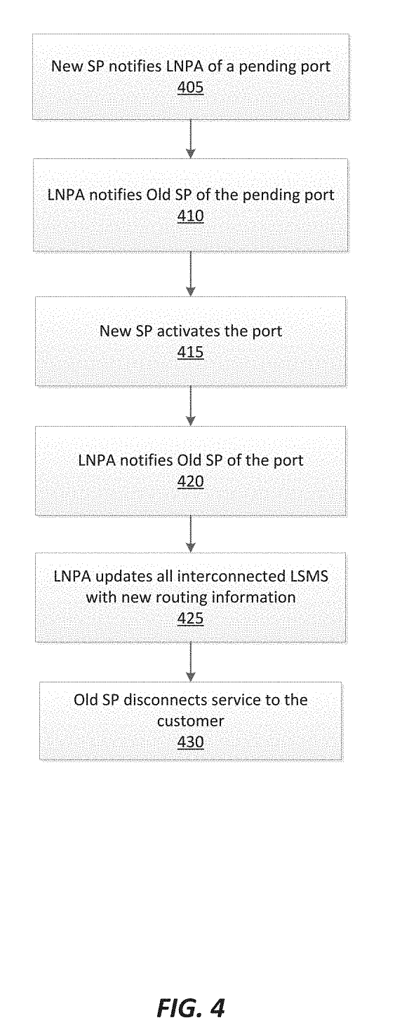

FIG. 4 illustrates some salient operations of a telephone number porting notification method according to an illustrative embodiment of the invention. The New SP may initiate the port by notifying the LNPA of a pending port, at step 405. The LNPA may then notify the old SP of the pending port, at step 410. The new SP can activate the port at step 415. Once the port is activated, the LNPA, at step 420, can notify the old SP that the telephone number porting is activated and that the telephone number has now been ported to the new SP. The LNPA may also, at step 425, update the telecommunications industry (e.g., via the LSMS of the connected SPs) that the telephone number is ported to the new SP. The old SP may disconnect service to the customer, at step 430, once the LNPA distributes the porting details to the telecommunications industry, and/or when the LNPA notifies the old SP that the telephone number has been ported. The new SP may then be responsible for the ported TN, including performing call routing and call management operations.

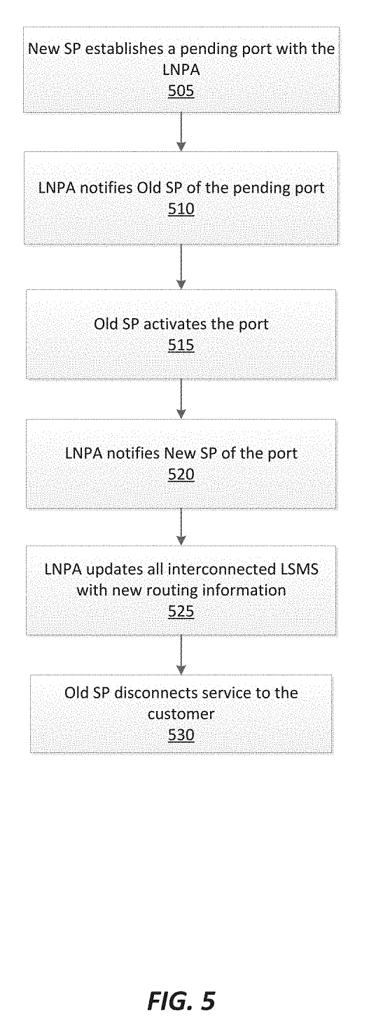

FIG. 5 illustrates some salient operations of a telephone number porting notification method according to an illustrative embodiment of the invention. The New SP may establish a pending port in the LNPA, at step 505. The LNPA may then notify the old SP of the pending port, at step 510. In some embodiments of the invention, the old SP (instead of the new SP) can activate the port, at step 515. Once the port is activated, the LNPA, at step 520 can notify the new SP that the telephone number porting is activated and that the telephone number has now been ported to the new SP. The LNPA may also, at step 525, update the telecommunications industry (e.g., via the LSMS of the connected SPs) that the telephone number is ported to the new SP. The old SP may disconnect service to the customer, at step 530, once the LNPA distributes the porting details to the telecommunications, and/or when the LNPA notifies the old SP that the telephone number has been ported. The new SP may then be responsible for the ported TN, including performing call routing and call management operations.

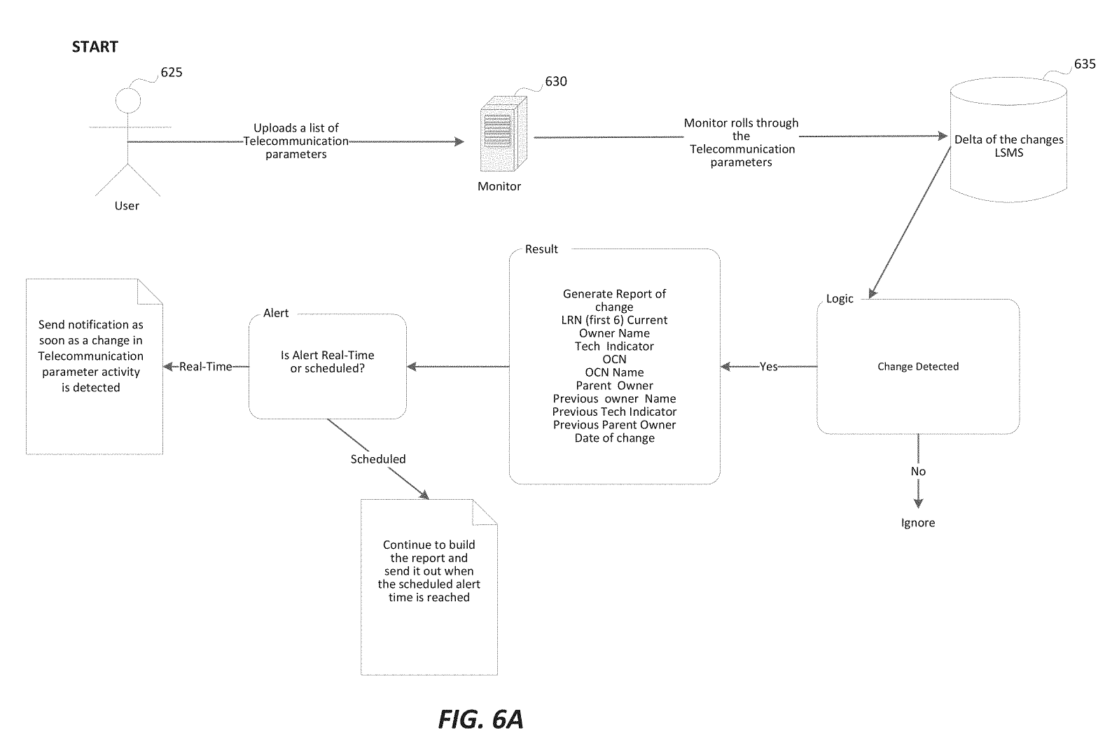

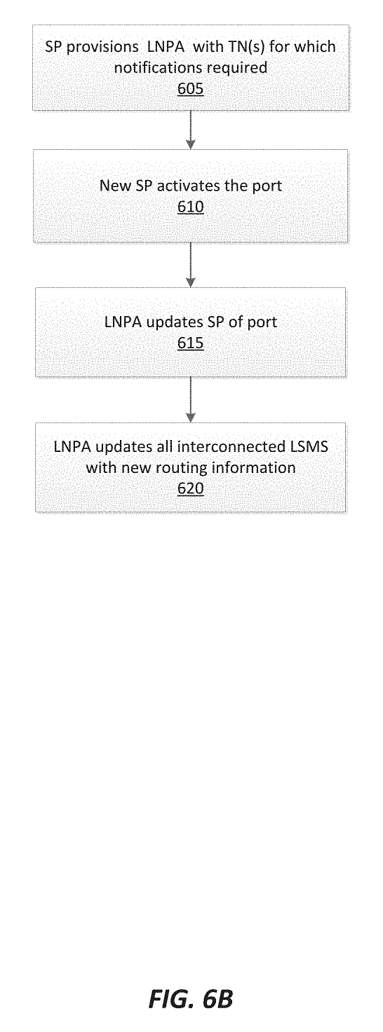

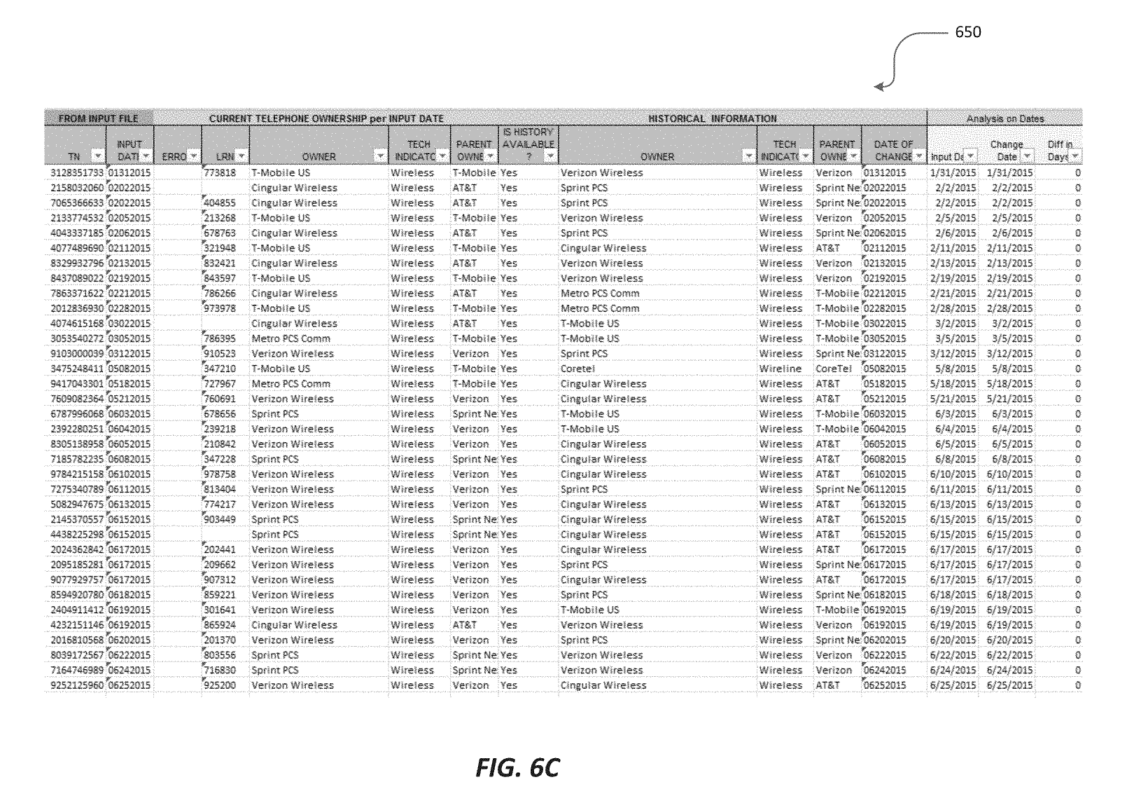

FIG. 6A illustrates some salient operations of a telecommunication parameter change notification method according to an illustrative embodiment of the invention. A user (e.g., a SP, a third-party, etc.) may wish to monitor one or more changes that may occur with regards to one or more telecommunication parameters. As discussed above, examples of telecommunication parameters include, but are not limited to, TN, LRN, NGLRN, SPID, Alternative SPID, Subscription Version (SV) type (e.g., wireless, wireline, VoIP, etc.), URI, pseudo SV/LRN, caller identifier, Line Info Database (LIDB), SS-7 Destination Point Codes (DPCs), service type, billing identifier, etc. The user 625 may provide a list of telecommunication parameters for tracking to a telecommunication parameters monitor 630. For example, the user may upload the list using a web-page associated with the telecommunication parameters monitor 630. The telecommunication parameters monitor 630 may process the telecommunication parameters in the list and determine if one or more properties associated with the parameter has changed. For example, the telecommunication parameters monitor 630 may compare the value of each parameter being monitored with a value saved in a database 635 (e.g., a LSMS database). If the telecommunication parameters monitor 630 detects a change in the value of a telecommunications parameter, it may generate a report of the change. The change report may include information of one or more properties associated with the telecommunication parameter. For example, the change report may include information of one or more of the following properties: TN, LRN, current owner name, technology indicator, Operating Company Number (OCN), OCN name, parent number, previous TN, previous LRN, previous owner name, previous technology number, previous parent owner, date of change, author of change, etc. FIG. 6C illustrates an example of a change report 650. The report may be saved in one or more formats (e.g., .csv, .txt, .pdf, etc.). The telecommunication parameters monitor 630 may then check the alert frequency associated with the change report. For example, if the alert frequency is real-time, the telecommunication parameters monitor 630 may send a notification when a change in the telecommunication property is determined. Other alert frequencies may be used (e.g., hourly, daily, weekly, quarterly, etc.).

FIG. 6B illustrates some salient operations of a telecommunication parameter change notification method. In particular, FIG. 6B illustrates the salient operations of a method for receiving notifications when a change occurs for a property associated with a telephone number (e.g., as part of telephone number porting). In some embodiments of the invention, a SP may request notification(s) when there is any change to a TN (e.g., when a TN is ported). For example, a SP may desire to track the porting of a particular TN. In some embodiments, the SP may request notification(s) for SPID, the LRN and/or NGLRN, SS7 Destination Point Codes, service type, Alternative SPID (to identify a reseller), billing ID, and end user location and type, zip code, etc. For example, the SP may request notification(s) if a TN in a particular zip code is ported. The SP, at step 605, may provide the LNPA with a telephone number identifier (or a list of telephone number identifier(s) that it wants to receive notifications for. When the LNPA receives a port request for a TN (e.g., at step 610), it may check whether the TN for which the porting request is received is one of the telephone number identifiers indicated by the SP at step 605. If there is a match, the LNPA updates the SP of the port request for the TN, at step 615. The LNPA may also, at step 620, update the telecommunications industry (e.g., via the LSMS of the connected SPs) that the telephone number is ported to the new SP. The old SP may disconnect service to the customer once the port is completed and/or when the LNPA notifies the old SP that the telephone number has been ported. The new SP may then be responsible for the ported TN, including performing call routing and call management operations.

The above description of the workings of this technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

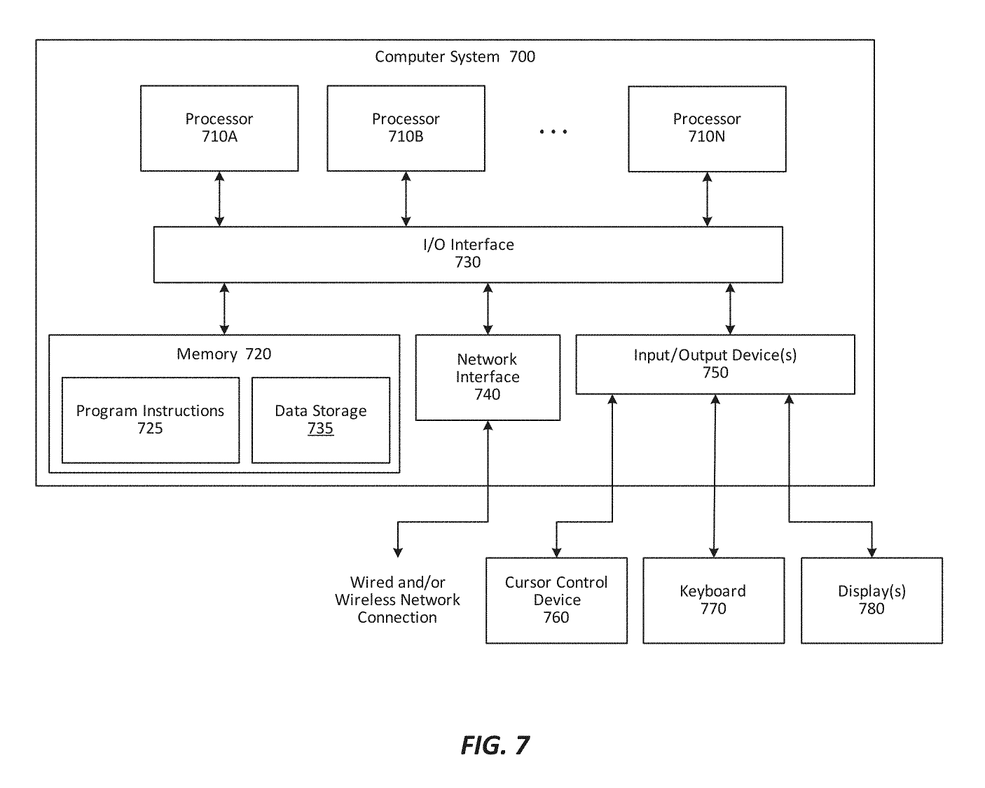

FIG. 7 illustrates the components of a computer system implementing the telephone number porting notification system according to various embodiments. The LNPA (and/or the LNPA intermediary) and/or the telecommunication parameters monitor, illustrated, for example, in FIGS. 2 and 6A may be implemented or executed, at least in part, by one or more computer systems. In various embodiments, computer system 700 may be a server, a workstation, a desktop computer, a laptop, a microcontroller, a system on a chip or the like. In some embodiments of the invention, computer system 700 may be implemented using a cloud-based infrastructure. In some embodiments, system 400 may be used to implement the telecommunication parameters monitor functionalities of FIGS. 3, 4, 5, 6A, and 6B. As illustrated, computer system 700 includes one or more processor(s) 710A-N coupled to a system memory 720 via an input/output (I/O) interface 730. Computer system 700 further includes a network interface 740 coupled to I/O interface 730, and one or more input/output devices 750, such as cursor control device 760, keyboard 770, and display(s) 780.

In various embodiments, computer system 700 may be a single-processor system including one processor 710A, or a multi-processor system including two or more processors 710A-N (e.g., two, four, eight, or another suitable number). Processor(s) 710A-N may include any processor capable of executing program instructions. For example, in various embodiments, processor(s) 710A-N may be general-purpose or embedded processors implementing any of a variety of instruction set architectures (ISAs), such as the x86, PowerPC®, ARM®, SPARC®, or MIPS® ISAs, or any other suitable ISA. In multi-processor systems, each of processor(s) 710A-N may commonly, but not necessarily, implement the same ISA.

System memory 720 may be configured to store program instructions (e.g., the real-time communications controller functions) and/or data accessible by processor(s) 710A-N. In various embodiments, system memory 720 may be implemented using any suitable memory technology, such as static random access memory (SRAM), synchronous dynamic RAM (SDRAM), non-volatile/Flash-type memory, or any other type of memory. As illustrated, program instructions and data implementing certain operations such as, for example, those described in connection with FIGS. 3-6B, may be stored within system memory 720 as program instructions 725 and data storage 735, respectively. Additionally or alternatively, the real-time communications controller functions may be a software program that is stored within system memory 720 and is executable by processor(s) 710A-N. In other embodiments, program instructions and/or data may be received, sent or stored upon different types of computer-accessible media or on similar media separate from system memory 720 or computer system 700. Generally speaking, a computer-accessible medium may include any tangible or non-transitory storage media or memory media such as electronic, magnetic, or optical media—e.g., disk or CD/DVD-ROM coupled to computer system 700 via I/O interface 730. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including, for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, I/O interface 730 may be configured to coordinate I/O traffic between processor(s) 710A-N, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor(s) 710A-N). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. In addition, in some embodiments some or all of the functionality of I/O interface 730, such as an interface to system memory 720, may be incorporated directly into processor(s) 710A-N.

Network interface 740 may be configured to allow data to be exchanged between computer system 700 and other devices attached to a network, such as an embedded real-time client and one or more mobile devices. In various embodiments, network interface 740 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 750 may, in some embodiments, include one or more display terminals, keyboards, keypads, touchpads, scanning devices, RFID readers, NFC readers, voice or optical recognition devices, or any other devices suitable for entering or retrieving data by one or more computer system 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

As shown in FIG. 7, memory 720 may include program instructions 725, configured to implement certain embodiments described herein, and data storage 735, comprising various data which may be accessible by program instructions 725. In an embodiment, program instructions 725 may include software elements of embodiments illustrated in the above figures. For example, program instructions 725 may be implemented in various embodiments using any desired programming language, scripting language, or combination of programming languages and/or scripting languages (e.g., C, C++, C#, .NET, Java™, JavaScript™, Perl, etc.). Data storage 735 may include data that may be used in these embodiments (e.g., recorded communications, profiles for different modes of operations, etc.). In other embodiments, other or different software elements and data may be included.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

From the foregoing, it will be appreciated that specific embodiments of the invention have been described herein for purposes of illustration, but that various modifications may be made without deviating from the scope of the invention. Accordingly, the invention is not limited except as by the appended claims.

1. A method for telephone number porting notification in a telecommunications network, the method comprising:
receiving, at a number portability administrator, a port request to port a telephone number from an old service provider to a new service provider;
transmitting, from the number portability administrator, a notification to the old service provider, wherein the notification comprises the telephone number;
determining, at the number portability administrator, routing information based on the port request; and
transmitting, from the number portability administrator, the routing information to at least one service provider.

2. The method of claim 1, wherein the routing information comprises at least one of the following:
telephone number;
location routing number;
non-geographic location routing number;
uniform resource locator;
uniform resource name;
uniform resource identifier;
outbound port identifier;
trunk group identifier;
IP address;
digital identity; and
service provider identifier.

3. The method of claim 1 wherein the old service provider is the same as the new service provider.

4. The method of claim 1, further comprising:
disconnecting service to the telephone number by the old service provider.

5. A method for telephone number porting notification in a telecommunications network, the method comprising:
receiving, at a number portability administrator from a new service provider, a pending port notification, wherein the pending port notification comprises information for transferring a telephone number from an old service provider to the new service provider;
transmitting, from the number portability administrator, a notification to the old service provider, wherein the notification comprises the telephone number;
receiving, at the number portability administrator, a port activation notification, wherein the port activation notification comprises information relating to porting of the telephone number; and
transmitting, from the number portability administrator to the old service provider, a notification informing the old service provider of the port.

6. The method of claim 5 further comprising:
determining, at the number portability administrator, routing information based on the port request.

7. The method of claim 6 further comprising:
transmitting, from the number portability administrator, the routing information to at least one service provider.

8. The method of claim 6, wherein the routing information comprises at least one of the following:
telephone number;
location routing number;
non-geographic location routing number;
uniform resource locator;
uniform resource name;
uniform resource identifier;
outbound port identifier;
trunk group identifier;
IP address;
digital identity; and
service provider identifier.

9. The method of claim 5 wherein the old service provider is the same as the new service provider.

10. The method of claim 5, further comprising:
disconnecting service to the telephone number by the old service provider.

11. The method of claim 5 wherein the port activation notification is received from the new service provider.

12. The method of claim 5 wherein the port activation notification is received from the old service provider.

13. A method for telephone number porting notification in a telecommunications network, the method comprising:
receiving, at a number portability administrator from a service provider, a list of telephone number identifiers;
receiving, at a number portability administrator, a port request to port a telephone number;
determining if the telephone number matches at least one telephone number identifier in the list of telephone number identifiers; and
if a match is obtained, transmitting a port notification to the service provider, wherein the port notification comprises the telephone number and the matching telephone number identifier.

14. The method of claim 13 wherein the telephone number identifier is at least one of:
telephone number;
location routing number;
non-geographic location routing number;
uniform resource locator;
uniform resource name;
uniform resource identifier;
trunk group identifier;
IP address;
digital identity;
billing identifier;
end user location;
zip code; and
service provider identifier.

15. The method of claim 13 further comprising:
determining, at the number portability administrator, routing information based on the port request.

16. The method of claim 15 further comprising:
transmitting, from the number portability administrator, the routing information to at least one service provider.

17. The method of claim 15, wherein the routing information comprises at least one of the following:
telephone number;
location routing number;
non-geographic location routing number;
uniform resource locator;
uniform resource name;
uniform resource identifier;
outbound port identifier;
trunk group identifier;
IP address;
digital identity; and
service provider identifier.

18. A system for telephone number porting notification in a telecommunications network, the system comprising:
at least one hardware processor coupled to a network; and,
a memory configured to store processor-executable components, wherein the processor-executable components further comprises:
a component for receiving, at a number portability administrator, a port request to port a telephone number from an old service provider to a new service provider;
a component for transmitting, from the number portability administrator, a notification to the old service provider, wherein the notification comprises the telephone number;
a component for determining, at the number portability administrator, routing information based on the port request; and
a component for transmitting, from the number portability administrator, the routing information to at least one service provider.

19. The system of claim 18, wherein the routing information comprises at least one of the following:
telephone number;
location routing number;
non-geographic location routing number;
uniform resource locator;
uniform resource name;
uniform resource identifier;
outbound port identifier;
trunk group identifier;
IP address;
digital identity; and
service provider identifier.

20. The system of claim 18 wherein the old service provider is the same as the new service provider.
